(19) United States
(12) Patent Application Publication
(10) Pub. No.: US 2019/0122178 A1
(43) Pub. Date: Apr. 25, 2019

(54) METHOD AND APPARATUS FOR AUTOMATING PHYSICAL EQUIPMENT REPLACEMENT AND MAINTENANCE

(71) Applicant: Telefonaktiebolaget LM Ericsson (publ), Stockholm (SE)

(72) Inventor: James KEMPF, Mountain View, CA (US)

(21) Appl. No.: 16/093,604

(22) PCT Filed: Apr. 25, 2016
(86) PCT No.: PCT/IB2016/052338

§ 371 Date: Oct. 12, 2018

(51) Int. Cl. G06Q 10/08; G06Q 10/10; G06Q 10/06

(52) U.S. Cl. CPC G06Q 10/08355; H04W 84/042; G06Q 10/063114; G06Q 10/1097

(57) ABSTRACT

A method and system is implemented by a computing device to improve the utilization of skilled technicians by use of automated delivery of telepresence devices to job sites. The method includes receiving a work order for a remote on location job, determining resource availability to complete the job, scheduling a route and delivery of resources and a telepresence device to a location of the job, and transmitting the route and resource information to a delivery vehicle.

### TECHNICAL FIELD

Embodiments of the invention relate to the field of automated services; and more specifically, to a method and apparatus for automating physical equipment replacement and maintenance.

### BACKGROUND

The maintenance and repair of many types of electronic devices requires the expertise of highly skilled technicians. Many types of such electronic devices are not easily moved and the technician must service these electronic devices on site. The devices commonly utilized in industries such as the telecommunications industry are examples of such electronic devices. The electronic devices may include junction boxes, digital subscriber line (DSL) cabinets and similar large and/or fixed devices.

In one example, Internet or cellular communication network operators often require repair and replacement of network equipment. This network equipment can be fixed or difficult to move and positioned at remote locations. Servicing such network equipment is complex and requires a skilled network technician, but the network technician may be required to spend hours driving through city traffic to remote destinations where the network equipment is located. Sitting in traffic or traveling long distances isn't a particularly productive use of the skilled network technician's time. In some instances, the repair or maintenance may be relatively quick taking only a short amount of time.

However, due to the technical nature of the repairs or maintenance and often the tools and resources required to complete the repair or work, it is not possible to send less skilled individuals whose time, cost and availability may be more suited for the task. As a result, companies may need to hire a larger number of skilled technicians to complete the requisite repair and maintenance work even though the amount of work would not require such hires if it could be conducted in a more time efficient manner or at the least the skilled technicians could accomplish more tasks in a timely fashion thereby improving the quality of the network operation.

### SUMMARY

In one embodiment a method is implemented by a computing device to improve the utilization of skilled technicians by use of automated delivery of telepresence devices to job sites. The method includes receiving a work order for a remote on location job, determining resource availability to complete the job, scheduling a route and delivery of resources and a telepresence device to a location of the job, and transmitting the route and resource information to a delivery vehicle.

In a further embodiment, a computing device is provided to execute the method to improve the utilization of skilled technicians by use of automated delivery of telepresence devices to job sites. The computing device includes a non-transitory storage medium having stored therein a scheduler and a resource tracker of a dispatch system, and a set of processors to execute the scheduler and resource tracker. The scheduler is configured to receive a work order for a remote on location job, to schedule a route and delivery of resources and a telepresence device to the location of the job, and to transmit the route and resource information to a delivery vehicle. The resource tracker is configured to determine resource availability to complete the job.

In another embodiment, a non-transitory machine-readable storage medium is provided that provides instructions that, if executed by a processor, will cause said processor to perform operations. The operations include receiving a work order for a remote on location job, determining resource availability to complete the job, scheduling route and delivery of resources and telepresence device to location of the job, and transmitting the route and resource information to a delivery vehicle.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a system for managing the automated maintenance and repair of equipment.

FIG. 2 is a flowchart of one embodiment of a process for managing the automated maintenance and repair of equipment.

FIG. 3A is a diagram of one example embodiment of a process for loading a delivery vehicle for the automated maintenance and repair system.

FIG. 3B is a diagram of one example embodiment of a process for directing the delivery vehicle to a job site and enabling a technician to remotely carry out the job.

FIG. 3C is a diagram of one example embodiment of a process for a technician to complete a job assigned by the automated maintenance and repair system.

FIG. 3D is a diagram of one example embodiment of a process for the pickup of resources from a job site after completion.

### DETAILED DESCRIPTION

The following description describes methods and apparatus for automated maintenance and repair. The method and apparatus receive job requests and schedule a delivery vehicle to deliver a telepresence device at or near the job site. A skilled technician can then utilize the telepresence device to carry out the maintenance and/or repair remotely. The delivery vehicle can be routed and provisioned with any necessary tools for completing a job request. Once the job has been completed, the technician can notify the system, which then schedules the pickup of the telepresence device and delivery vehicle is again routed to the job site to pick up the telepresence device and any other remaining resources. In this manner, the time allotted to a given job can be dramatically reduced thereby increasing the productivity of the skilled technician. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

Overview

The embodiments of the invention describes a method whereby the physical maintenance and replacement of equipment (e.g., network equipment) at remote locations such as the equipment in curbside digital subscriber line (DSL) cabinets, cell towers, fiber connections, overhead wires, and similar equipment and electronic devices can be automated so that human involvement is structured through telepresence devices (e.g., telepresence robots) delivered by automated vehicles rather than requiring the physical presence of a human at the job site. In particular, this method and apparatus saves the time of skilled technicians who have a high cost for companies and limited availability, making their time more efficient and cost effective.

The embodiments overcome many of the limitations of the prior art. In particular, in the prior art, skilled technicians are required to spend hours on the road driving through traffic to reach the location of a maintenance job. Their time is better spent actually performing the maintenance and leaving the driving to autonomous vehicles. The prior art thus ineffectively and inefficiently utilizes the time of skilled technicians. In addition, the skilled technicians would likely be responsible for the scheduling and routing of their jobs as well as making the decisions on the resources required to perform the jobs. This further added to the time required that was non-essential for the skills of the technician.

The embodiments overcome these limitations of the prior art. The embodiments, replaces the human-on-the-spot truck roll with a combination of an autonomous vehicle and a small, mobile or easily transported, telepresence device (e.g., a robot) that can wield specialized tools for effecting the necessary repairs or maintenance for a job. The embodiments are describe with regard to the example application of the system and methods to maintenance and repair jobs in the field of telecommunications. However, one skilled in the art would understand that the principles and structures described herein with regard to this context may be applied to other similar environments, especially those where high technology equipment is to be serviced by skilled technicians at a remote location from the skilled technicians.

The embodiments utilize an autonomous or remotely guided vehicle to deliver a telepresence device that will operate locally to carry out a job at the direction and control of a skilled technician. For example, a typical telecommunication service van can be converted to become an autonomous vehicle that does not require any direct human guidance. At a dispatch center or similar location such as a resource facility (i.e., a location where supplies for the job can be stored or obtained), the autonomous delivery van can loaded with telepresence devices and necessary job resources. These job resources can be tools that are affixed or provided to the telepresence device. For example, the telepresence device can be a remotely controlled robot with a camera and with tools specific to the jobs required that day and any replacement parts or equipment that might be needed for the jobs. The autonomous delivery van is programmed by a dispatch system with the locations of the equipment needing service. The autonomous delivery van then threads its way through traffic until it reaches the places where the equipment is located.

In some embodiments, using a low-latency fifth generation (5G) wireless network, the delivery vehicle or telepresence device sends a notification or calls back to the dispatch center informing the dispatch system and/or communication service technician that it has arrived at a designated job site. The dispatch system may notify a communication service technician of the readiness of the telepresence device at the job site, then the communication service technician can take control of the telepresence device through the same 5G connection and guides it to the piece of equipment requiring maintenance or replacement. The communication service technician fixes the equipment using the video on the telepresence device and the remotely controlled tools to perform the job.

In some embodiments, the telepresence device may be equipped with 3D cameras and virtual reality software, the skilled technician can wear a virtual reality headset and accomplish the task in a fully immersive user interface (UI). If the wireless link with the telepresence device has low enough latency and the telepresence device is equipped with gear to provide haptic feedback, the technician can get haptic feedback for operations such as removing screws, and performing similar jobs. When the job is done, the communication service technician guides the telepresence device back to the automated delivery van or to a pickup location, and notifies the dispatch system of the job completion. The dispatch system can then notify the autonomous delivery van to return to pick up the telepresence device and return it to the dispatch center, resource facility or go to the next job. If the autonomous delivery van can carry telepresence devices for multiple jobs, then it can move off and deliver others to other job sites while the technician is working at any given job site. The examples of a 5G network and autonomous delivery van are provided by way of example and not limitation. Other types of communications networks, including older 4G networks, can be utilized and other types of autonomous or remotely guided vehicles such as drones, cars or similar vehicles can be used. Functionality in 4G networks or any network with higher latency may be more limited where low latency plays an important role in the functionality, for example haptic feedback may not be a functioning option for 4G networks. In some embodiments, the telepresence device may have the capacity to traverse long distances and the delivery function can be merged with the repair functions such that only a single device is utilized rather than the separate autonomous delivery vehicle and telepresence devices.

In some cases, the amount of traffic congestion may be so great that the autonomous delivery vehicle may be can be an autonomously guided drone, which would fly to the location of the equipment, land, and deliver the telepresence device or wait for the technician to finish the job and fly off to the next job with the telepresence device or back to the dispatch center. With a larger drone, a collection of telepresence devices for various jobs could be carried in a cassette and dropped off at various locations, then retrieved later. If the area around the equipment needing service is too tight for a drone landing, the drone could lower the robot down on a cable and retrieve it in the same manner. Where multiple types of autonomous delivery vehicles are available to a dispatch system, the dispatch system can select the autonomous vehicle best suited for the delivery of the resources and telepresence device in a timely manner.

In the absence of a regulatory regime favorable to automated vehicles, a dispatch system also might integrate the use a service such as third party or manned delivery service which utilizes a human driver to drop off the telepresence devices and retrieve them, should the dispatch system operator not want to bear the cost of maintaining a fleet of delivery vehicles. Since the delivery vehicles are no longer specialized, any vehicle may do. Vehicle drivers need not have any specialized training in equipment maintenance and repair, since their only function is to deliver the telepresence devices to the job site and later retrieve them, while the skilled (e.g., network) technician in the dispatch center or other location remote from the job site takes care of the technical work via the telepresence device.

The embodiments provide many advantages over the prior art. Skilled technicians, such as communication service technicians, typically complete as few as two jobs a day since often they must drive one to two hours in city traffic to reach the job site such as the location of a piece of equipment needing service. Driving is not an efficient use of their time. With the embodiments of the invention, a skilled technician can sit at the dispatch center, at home or any office location and complete jobs as the telepresence devices are delivered to the job site. The automated delivery vehicle carrying the telepresence device could in principle be sent before the skilled technician arrived at work in the morning. In this way, a skilled technician could complete perhaps 4-6 jobs per day instead of 1 or 2 jobs, depending on the complexity of the jobs, thus doubling or tripling their productivity. The limiting factor would be the pre-positioning of telepresence devices and resources for a job and the complexity of the job rather than any lost time due to commuting to the job site by the skilled technician.

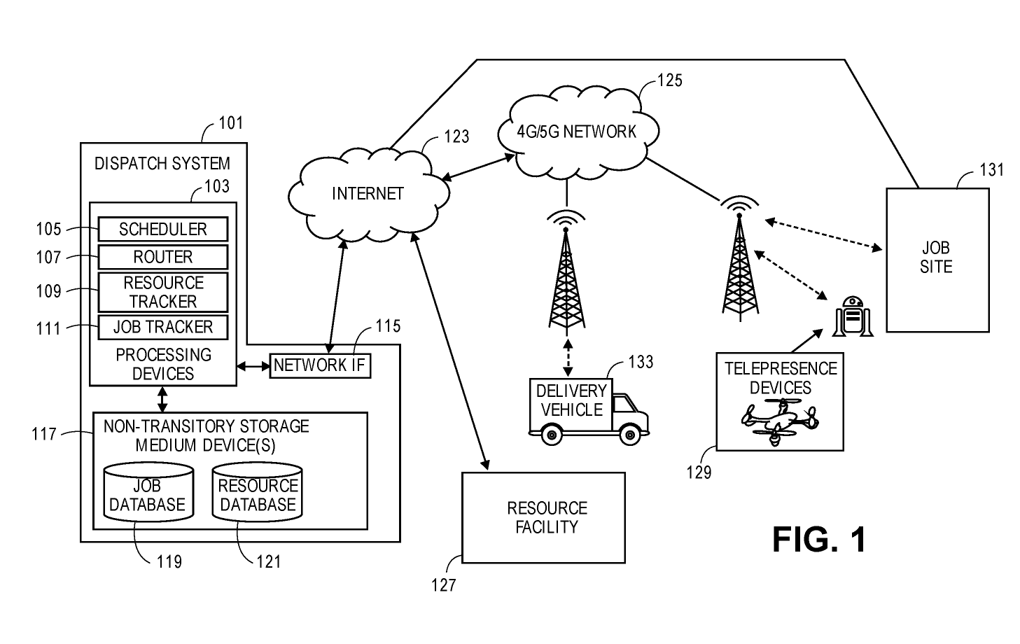

FIG. 1 is a diagram of one embodiment of a system for managing the automated maintenance and repair of equipment. The management of the automated maintenance and repair of equipment, in one embodiment, is managed via a dispatch system 101. A dispatch system 101 is illustrated a single system, however, one skilled in the art would understand that it can be a single computing system, a distributed system, hosted at a remote server, hosted in a cloud system or similarly implemented. The dispatch system 101 includes a set of processing devices 103, a set of non-transitory storage medium devices 117, and a set of network interfaces 115. The set of processing devices 103 can be any combination or number of general purpose or application specific integrated circuit (ASIC) processing devices. A ‘set,’ as used herein refers to any positive whole number of items including one item. The set of non-transitory storage medium devices 117 can be any combination and number of optical, magnetic, solid-state or similar storage medium devices that are capable of long term data storage. The set of network interfaces 115 can include any number and variety of networking devices that enable a computing system to communicate with a network such as a local area network or wide area network (e.g., the Internet 123). The network interfaces 115 can communicate with other devices using any wired or wireless medium. In some embodiments, the network interface 115 enables the communication of the dispatch system 101 with autonomous delivery vehicles 133, telepresence devices 129 and job sites 131 via any combination of intermediate computing devices including the Internet 123 and cellular communication systems such as 4G or low latency 5G networks 125.

The dispatch system 101 can include a set of subsystems. The subsystems can include a scheduler 105, router 107, resource tracker 109, a job tracker 111 and similar subsystems. This organization and delineation of subsystems is provided by way of example and not limitation. One skilled in the art would understand that any organization and separation of functions into individual subsystems is within the scope of the embodiments. The functions described can be implemented in a single system or any number of separate subsystems.

The scheduler 105 is a subsystem of the dispatch system 101 that organizes the jobs and the order in which they are serviced by scheduling the assignment of delivery vehicles 133 and the delivery of telepresence devices 129 to job sites 131. The scheduler 105 can use any scheduling algorithm or process to determine the order in which jobs are to be serviced. The scheduler 105 can work in combination with the other subsystems to ensure the assignment of the appropriate resources to a job and the completion of the job that clears it with the scheduler. The jobs may be tracked by the job tracker 111 in a job database 119. The scheduler 105 can communicate with other components such as a resource facility 127 (e.g., an equipment warehouse or storage facility), delivery vehicles 133, telepresence devices 129 and job sites 131. The scheduler 105 may send notifications to the resource facilities 127, delivery vehicles 133, telepresence devices 129 and similar components to notify them of scheduling and distribution of resources to perform a set of jobs. The notifications may list resources to be loaded and delivered at a dispatch center, resource facility 127 and job site 131, as well as identify the type and particular delivery vehicle 133 and/or telepresence device 129.

The router 107 is a subsystem that determines a route that a delivery vehicle 133 takes to reach a job site 131 or a set of job sites over the course of a set of jobs. The router 107 can utilize maps with route information and traffic data to determine ideal timings and routes between locations for the delivery vehicle 133. The router 107 can also update these routes while being implemented if conditions change, such as changes in traffic patterns like increased congestion, accidents or road closures.

The resource tracker 109 keeps track of the various resources utilized by the dispatch system 101 and may store this information and maintain it in a resource database 121. The resource tracker 109 can keep track of parts used in repair operations and similar components. In some embodiments, the resource tracker 109 can also monitor the types and availability of telepresence devices and delivery vehicles. The resource tracker 109 may play a role in determining the resources utilized for a given job type or resources requested by a technician to complete a given job. The scheduler 105 can query the resource tracker 109 to determine resource availability in the process of setting a schedule for job assignment and completion. The resources tracked can include resources stored at a dispatch center, at resource facilities 127, on delivery vehicles 133, with telepresence devices 129 and at job sites 131. The resource tracker 109 can communicate with the other components (e.g., resource facility 127, delivery vehicles 133, or telepresence devices 129) to ascertain the available resources and their condition.

The job tracker 111 can process job requests that a received, maintain a job database 119 that defines the details of such jobs including assigned resources and scheduling, and can clear jobs after they have completed. The job tracker 111 can be updated with new job information automatically, by customer service personnel or technicians. Automated job creation can be related to regular maintenance such as a yearly system check or similar job type. Customer service personnel may receive phone calls or other communications requesting repair or service of electronic equipment on site. Each of the jobs defined to handle these requests are input into the job database 119 where the scheduler 105 and resource tracker 109 coordinate to ensure that each of the jobs is serviced by the resources available according to an ordering of the scheduler algorithm.

These subsystems can be executed by the set of processing devices 103. The code for these subsystems may be stored in the set of non-transitory storage medium devices 117 or similarly stored. The job database 119 and resource database 121 can be similarly stored by the non-transitory storage medium devices 117. The communication of data of the subsystems to external components such as delivery vehicles 133, resource facilities 127, telepresence devices 129 and similar components can be via the network interfaces 115 and intermediate networks 123 and 125.

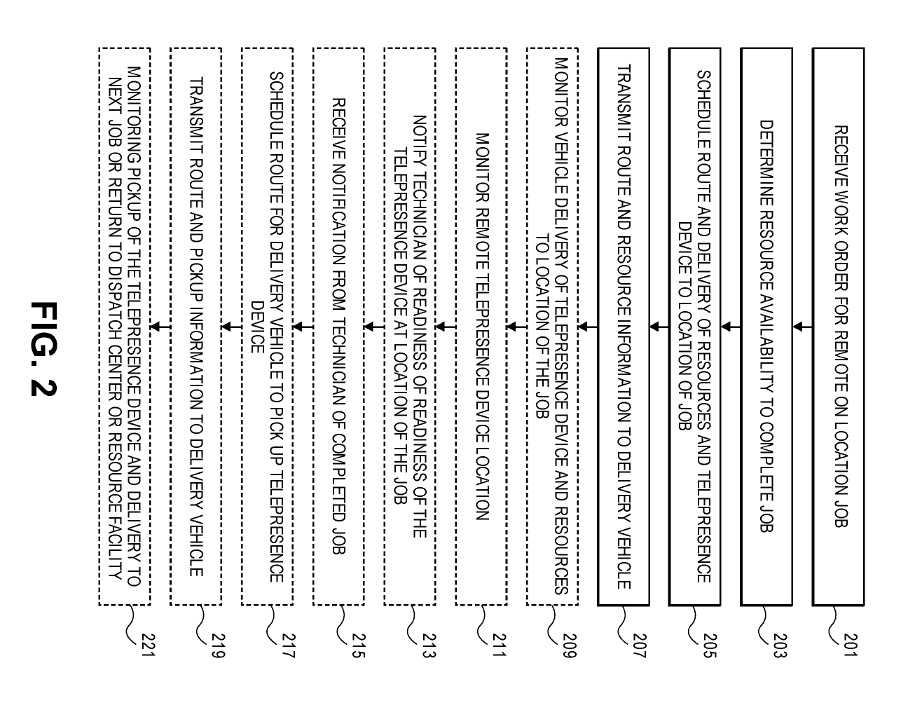

FIG. 2 is a flowchart of one embodiment of a process for managing the automated maintenance and repair of equipment. In one embodiment, the process is initiated in response to receiving a job request for a remote on location job (Block 201). The job can be automatically generated by the dispatch system to service a regular maintenance job or can be generated by a customer service person in response to a call or electronic request. In some further embodiments, other individuals can generate electronic job requests or input them into the dispatch system. The input of the job into the dispatch system can include any details about the job, including the type of job, the location, and a description of the problem, requester and similar information.

Based on this initial input of data describing the problem to be solved or the type of the job, the dispatch system may determine the resources needed for the job and check availability of these resources (Block 203). The resource tracker and scheduler of the dispatch system may coordinate this aspect of the job processing. The scheduler then coordinates with the router to determine a route to the job site (Block 205). The scheduler and resource tracker may select a delivery vehicle or service to deliver the telepresence device along with the requisite resource (e.g., tools and parts) to accomplish the job. The scheduler may organize multiple jobs using the same or overlapping resources, for example, multiple telepresence device may be loaded onto a single delivery vehicle and dropped at separate job sites. For sake of clarity, the discussion herein gives the example of scheduling a single job.

Once the schedule, resources and route information has been determined by the dispatch system, then the dispatch system may communicate the relevant aspects to the delivery vehicle, resource facilities, telepresence device and similar components of the system that will bring it into effect (Block 207). The dispatch system can then monitor the implementation of the schedule and routing by the delivery vehicle and similar components (Block 209). If conditions change, such as traffic, the dispatch system can update the routing and scheduling information. Similarly, the location of the telepresence device is monitored by the dispatch system (Block 211). Once it reaches its destination near the job site, then the dispatch system can notify the technician that the telepresence device and the associated resources are ready to perform the associated job (Block 213).

The technician can then take control of the telepresence device and begin to work on the associated job using the remote control and repair user interface of a network computer at the dispatch center or similar location. When the technician has completed the work, a notification is set to dispatch system (Block 215). The dispatch system can then schedule the pickup of the telepresence device and any remaining unused resources (Block 217). Once the schedule and routing for the pick up has been determined, the dispatch system can transmit the schedule, resource information and route information to the delivery vehicle (Block 219). The dispatch system may then monitor the progress of the delivery vehicle and the return of the telepresence devices to the dispatch center, resource facility or a delivery to another job site (Block 221).

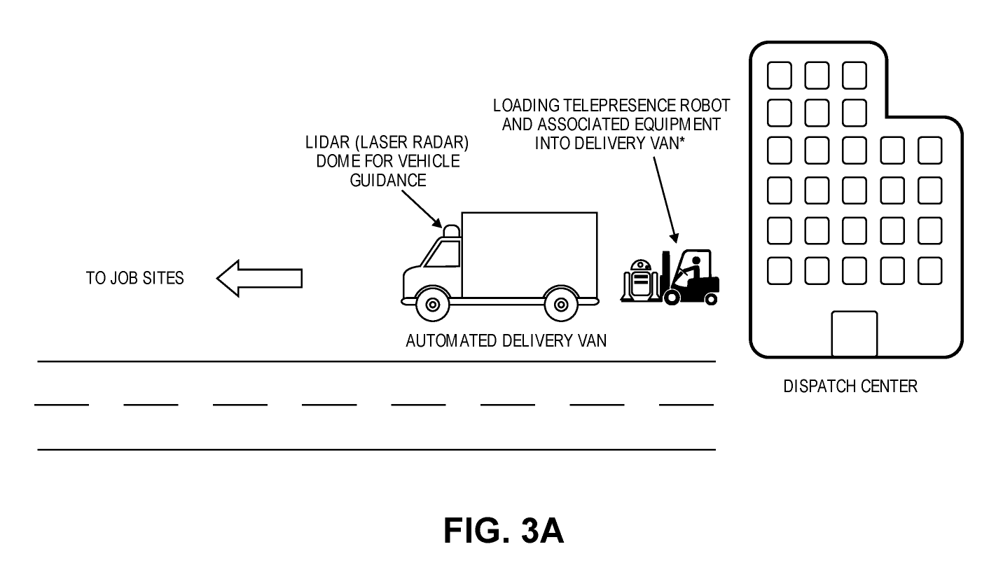

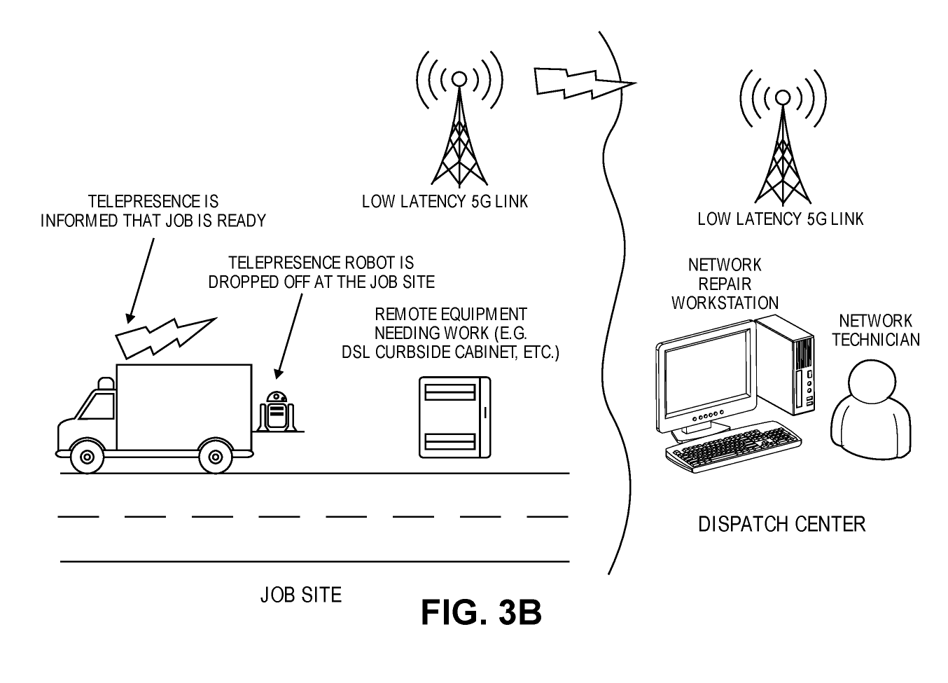

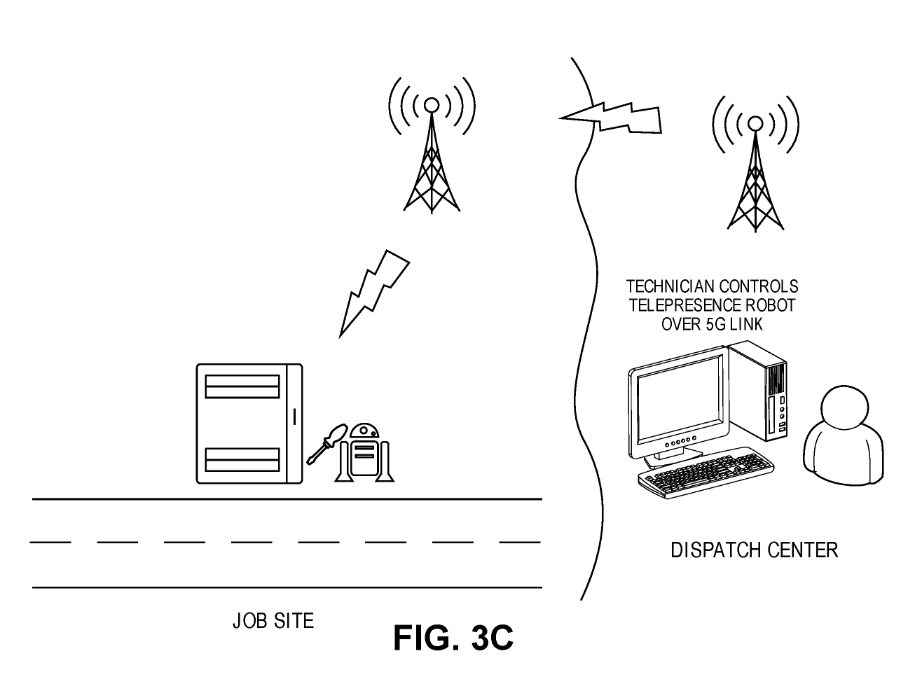

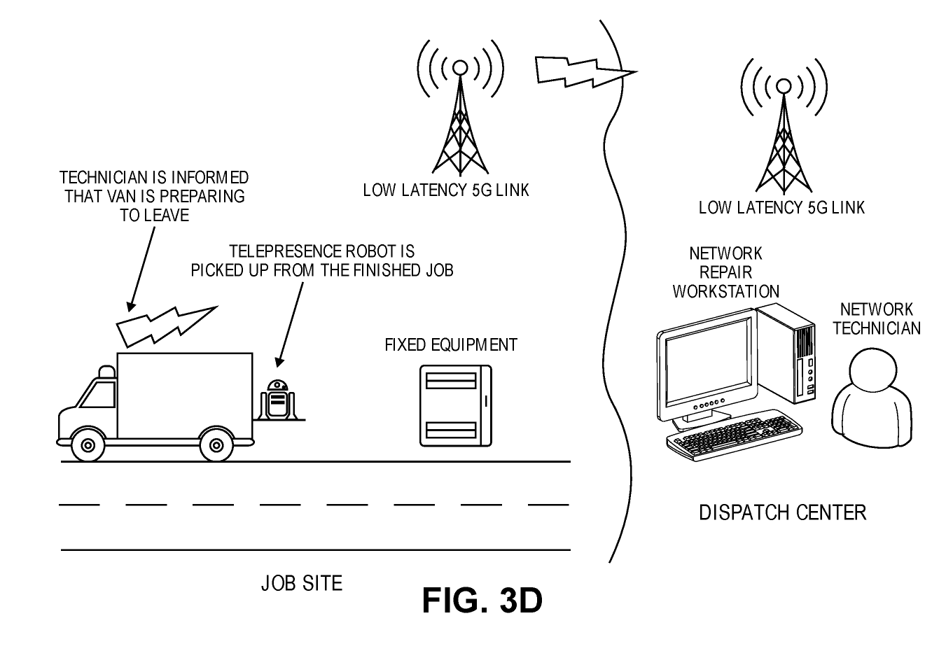

FIG. 3A is a diagram of one example embodiment of a process for loading a delivery vehicle for the automated maintenance and repair system. FIGS. 3A-3D relate to a single example for sake of illustration and not limitation. These Figures illustrate the autonomous delivery van scenario only, this is not to preclude the drone, drone cassette, or ride service scenarios discussed herein above. These are all alternative options for delivering and retrieving the telepresence devices in a manner that reduces the dispatch systems operating expenses and/or more rationally partitions the work of jobs in a way that better matches the skills of the various workers involved (i.e., skilled network technician vs. semi-skilled driver).

In the illustration of FIG. 3A, the example embodiment is given of loading a telepresence device, in this case a telepresence robot and associated equipment (e.g., tools, replacement Parts and equipment, and similar resources) into the autonomous delivery vehicle, which in this case is an automated delivery van. The automated delivery van in this example is an autonomous vehicle that is capable of operating without a human driver or any human assistance. A laser radar (LIDAR), in one example embodiment, is installed to enable the on board driving control systems to have visibility on road conditions and enable the on board driving control system to navigate the automated delivery van on the streets and amidst traffic on the streets. In this example, the telepresence device is a telepresence robot, which may be automatically or manually loaded onto the automated delivery van at the dispatch center or in other cases at a resource facility. The example telepresence robot can be loaded along with any tools or other resources required by the set of jobs for which the telepresence robot is being dispatched. In some embodiments, multiple telepresence devices may be loaded onto a single autonomous vehicle, with each being dropped at or near a job site along with any necessary resources (e.g., tools or replacement parts).

FIG. 3B is a diagram of one example embodiment of a process for directing the delivery vehicle to a job site and enabling a technician to remotely carry out the job. The automated van receives the scheduling information from the dispatch system. The scheduling information can include route information that directs the autonomous delivery vehicle to each of the job sites to drop off each of the telepresence devices. The initial job requests can be automatically generated by the dispatch system or via a customer service person.

In the illustrated example, the automated vehicle drives to the job site and drops off the telepresence robot and any additional tools or equipment needed for the job, then informs the technician back at the dispatch center via a low latency 5G link that the job is ready. The automated van proceeds to the next job site to deliver the appropriate telepresence robot or waits for the completion of this job. The network technician may be sitting at a network repair workstation running a telepresence application connected to the 5G link. If the robot is equipped with a three dimensional (3D) camera system, the network technician can wear an immersive virtual reality headset. If the 5G link has sufficiently low enough latency, the robot can be equipped with haptic equipment so the technician can get haptic feedback for operations such as tightening screws, and similar operations. In order to use haptics, however, the distance between the dispatch center and job site must be within a maximum 300 km (speed of light) distance. Routing delays, and similar issues could reduce that distance by about half.

In the illustrated example, the telepresence robot is dropped at a remote equipment site along with its tools. The delivery vehicle or the telepresence robot itself may signal the dispatch center or assigned network technician that the telepresence robot is ready and is in position. The network technician using a network repair workstation or similar user interface then takes control of the telepresence robot and completes the job over a low latency 5G network connection.

FIG. 3C is a diagram of one example embodiment of a process for a technician to complete a job assigned by the automated maintenance and repair system. In this figure, the network technician uses the telepresence robot, via an associated control application on his network workstation, which may include a virtual reality headset and haptic feedback, to fix the equipment. Equipment needing replacement is installed by the telepresence robot. The telepresence robot may be equipped with any arrangement of tools and capabilities that are built in or used through a general purpose control mechanism such as a tool wielding arm or similar capability. The network technician uses the control software to signal the dispatch system once the job has completed. The network technician may position the telepresence robot for pick up or the dispatch system may take control of the telepresence robot to automatically position it for pick up. The dispatch system may then schedule the automated delivery van to pick up the telepresence robot and any equipment that is to be returned.

FIG. 3D is a diagram of one example embodiment of a process for the pickup of resources from a job site after completion. At the direction of the scheduler and router of the dispatch system, the automated van returns to the job site and picks up the telepresence robot, then proceeds to another job, or returns to the dispatch center depending on the day's roster of jobs. Thus, the examples provide an illustration of a scenario for the application of the dispatch system.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method implemented by a computing device to improve utilization of skilled technicians by use of automated delivery of telepresence devices to job sites, the method comprising:
receiving a work order for a remote on location job;
determining resource availability to complete the job;
scheduling a route and delivery of resources and a telepresence device to a location of the job; and
transmitting the route and resource information to a delivery vehicle.

2. The method of claim 1, further comprising:
monitoring vehicle delivery of the telepresence device and resources to the location of the job.

3. The method of claim 1, further comprising:
monitoring telepresence device location; and
notifying a technician of readiness of the telepresence device at location of the job, in response to the telepresence device location being in proximity to the location of the job.

4. The method of claim 1, further comprising:
receiving notification from technician of the job being completed.

5. The method of claim 4, further comprising:
scheduling route for delivery vehicle to pick up telepresence device, in response to receiving the notification of the job being completed.

6. The method of claim 1, further comprising:
transmitting route and pickup information to the delivery vehicle via a low latency fifth generation cellular network or a fourth generation cellular network.

7. The method of claim 1, further comprising:
monitoring pickup of the telepresence device and delivery to next job or return to dispatch center or resource facility.

8. The method of claim 1, wherein transmitting the route to the delivery vehicle is via a low latency fifth generation cellular network or a fourth generation cellular network.

9. A computing device to execute a method to improve utilization of skilled technicians by use of automated delivery of telepresence devices to job sites, the computing device comprising:
a non-transitory storage medium having stored therein a scheduler and a resource tracker of a dispatch system; and
a set of processors to execute the scheduler and resource tracker, the scheduler to receive a work order for a remote on location job, to schedule route and delivery of resources and telepresence device to location of the job, and to transmit the route and resource information to a delivery vehicle, the resource tracker to determine resource availability to complete the job.

10. The computing device of claim 9, wherein the set of processors is further to execute a job tracker, the job tracker and resource tracker to monitor vehicle delivery of the telepresence device and resources to the location of the job.

11. The computing device of claim 10, wherein the job tracker and resource tracker to further monitor telepresence device location, and notify a technician of readiness of the job, in response to the telepresence device location being in proximity to the location of the job.

12. The computing device of claim 10, wherein the job tracker to further receive notification from technician of the job being completed.

13. The computing device of claim 10, wherein the scheduler and a router to schedule a route for the delivery vehicle to pick up the telepresence device, in response to receiving a notification of the job being completed, to transmit the route and pickup information to the delivery vehicle via a low latency fifth generation cellular network or a fourth generation cellular network, and the job tracker to monitor pickup of the telepresence device and delivery to next job or return to dispatch center or resource facility.

14. A non-transitory machine-readable storage medium that provides instructions that, if executed by a processor, will cause said processor to perform operations comprising:
receiving a work order for a remote on location job;
determining resource availability to complete the job;
scheduling a route and delivery of resources and telepresence device to location of the job; and
transmitting the route and resource information to a delivery vehicle.

15. The non-transitory machine-readable storage medium of claim 14, further comprising instructions that, if executed, will cause the processor to perform operations further comprising:
monitoring vehicle delivery of the telepresence device and resources to the location of the job.

16. The non-transitory machine-readable storage medium of claim 14, further comprising instructions that, if executed, will cause the processor to perform operations further comprising:
monitoring telepresence device location; and
notifying a technician of readiness of the job, in response to the telepresence device location being in proximity to the location of the job.

17. The non-transitory machine-readable storage medium of claim 14, further comprising instructions that, if executed, will cause the processor to perform operations further comprising:
receiving notification from technician of the job being completed; and
scheduling route for delivery vehicle to pick up telepresence device, in response to receiving the notification of the job being completed.

18. The non-transitory machine-readable storage medium of claim 17, further comprising instructions that, if executed, will cause the processor to perform operations further comprising:
transmitting route and pickup information to the delivery vehicle via a low latency fifth generation cellular network or a fourth generation cellular network; and
monitoring pickup of the telepresence device and delivery to next job or return to dispatch center or resource facility.
